(19) United States
(12) Patent Application Publication
(10) Pub. No.: US 2026/0362029 A1
(43) Pub. Date: Nov. 12, 2026

(54) IMAGE SENSOR DEVICE OPERATING BASED ON MASKED CLOCK SIGNAL

(71) Applicant: Samsung Electronics Co., Ltd., Suwon-si (KR)

(72) Inventors: YUNJAE SUH, Suwon-si (KR); SEUNGNAM CHOI, Suwon-si (KR); IL-JOONG KIM, Suwon-si (KR); SEHO PARK, Suwon-si (KR); JAEJUNG PARK, Suwon-si (KR); KWANGMIN LEE, Suwon-si (KR); JESUK LEE, Suwon-si (KR); SOONIK CHO, Suwon-si (KR)

(21) Appl. No.: 19/451,470

(22) Filed: Jan. 16, 2026

(30) Foreign Application Priority Data
May 7, 2025 (KR) 10-2025-0059003

(51) Int. Cl. H04N 25/60; H04N 25/709; H04N 25/76; H04N 25/77

(52) U.S. Cl. CPC H04N 25/60; H04N 25/709; H04N 25/77; H04N 25/7795

(57) ABSTRACT

An image sensor device includes a common voltage line, an image pixel, and a voltage converting circuit that generates a boost voltage for a voltage level of the common voltage line based on a masked clock signal, and a pixel driving circuit that provides one or more pixel control signals to the image pixel. The one or more pixel control signals are generated based on the boost voltage.

### CROSS-REFERENCE TO RELATED APPLICATION

This application claims priority to and the benefit of Korean Patent Application No. 10-2025-0059003 filed with the Korean Patent Office on May 7, 2025, the entire contents of which are incorporated herein by reference.

### BACKGROUND

### a. Field

The present disclosure relates to an image sensor device.

### b. Description of the Related Art

Components of an image sensor device may receive various voltages, such as a power supply voltage and a ground voltage, through voltage lines. However, voltage levels required for some operations of the image sensor device may not be provided directly from the voltage lines.

The image sensor device may generate a boost voltage by boosting a voltage provided from the voltage lines. For example, an image sensor device may include a voltage converting circuit that generates a boost voltage by repeatedly performing a switching operation for a voltage line. However, if the voltage converting circuit repeatedly performs the switching operation on the voltage line, noise may occur in the voltage level of the voltage line due to the switching operation, and this may also cause noise in the image generated from the image sensor device.

### SUMMARY

The present disclosure is intended to provide an image sensor device such that influence of voltage line noise on image is minimized.

According to embodiments, an image sensor device comprises a common voltage line, an image pixel, and a voltage converting circuit configured to generate a boost voltage for a voltage level of the common voltage line based on a masked clock signal, and a pixel driving circuit configured to provide one or more pixel control signals to the image pixel, wherein the one or more pixel control signals are generated based on the boost voltage.

According to embodiments, an image sensor device comprises an image pixel array including an image pixel, a sensor driver configured to control the image pixel, a ramp generation circuit configured to generate a ramp signal having a voltage level that changes linearly during a first ramp period and a second ramp period, an analog-to-digital converting circuit configured to identify a first pixel reset voltage for the image pixel based on a voltage level of the ramp signal during the first ramp period, and configured to identify a first pixel data voltage for the image pixel based on a voltage level of the ramp signal during the second ramp period, a sensor controller configured to provide a mask signal to the sensor driver, wherein the mask signal has a first logic level during a first masking period included in the first ramp period and a second masking period included in the second ramp period, and the mask signal has a second logic level during a time period between the first ramp period and the second ramp period.

According to embodiments, an image sensor device is configured to receive a power supply voltage, the image sensor device comprises a clock masking circuit configured to generate a masked clock signal based on a mask signal and a clock signal, a voltage converting circuit configured to generate a boost voltage that is higher than the power supply voltage based on the masked clock signal, and an image pixel array configured to be controlled based on the boost voltage.

According to embodiments a method of operating an image sensor device comprises generating a masked clock signal based on a mask signal and a clock signal, generating a boost voltage based on the masked clock signal, wherein the boost voltage is higher than a power supply voltage received by the image sensor device, and controlling an image pixel array of the image sensor device based on the boost voltage.

According to embodiments of the method comprises generating a ramp signal having a voltage level that changes linearly during a first ramp period and a second ramp period.

According to embodiments of the method, the mask signal has a first logic level during a first masking period included in the first ramp period and a second masking period included in the second ramp period, and the mask signal has a second logic level during a time period between the first ramp period and the second ramp period.

According to embodiments of the method, the masked clock signal has a constant logic level while the mask signal is at the first logic level, and the masked clock signal toggles while the mask signal is at the second logic level.

### BRIEF DESCRIPTION OF THE DRAWINGS

FIG. 1 is a block diagram showing a configuration of an image sensor device according to an embodiment of the present disclosure.

FIG. 2 is a block diagram showing some of the components of FIG. 1 in more detail.

FIG. 3 is a diagram showing relation between the mask signal, the power supply voltage and ground voltage in FIG. 2.

FIG. 4 is a block diagram showing a part of the configuration of the image sensor device of FIG. 1 in more detail.

FIG. 5 is a drawing showing some of the configurations of FIG. 4 in more detail.

FIG. 6 is a timing diagram showing an operation of the image sensor device of FIG. 5.

FIG. 7 is a diagram exemplarily showing how the sensor controller of FIG. 1 controls the mask signal.

FIG. 8 is a block diagram showing a configuration of the sensor driver of FIG. 1 according to an embodiment.

FIG. 9 is a block diagram showing a configuration of the sensor driver of FIG. 1 according to an embodiment.

FIG. 10 is a circuit diagram exemplarily showing a configuration of a voltage converting circuit.

FIG. 11 is a block diagram showing the configuration of an image sensor device according to an embodiment.

### DETAILED DESCRIPTION OF THE EMBODIMENTS

Hereinafter, various embodiments will be described in detail and clearly to such an extent that an ordinary one in the art easily implements the present disclosure. Specific details such as detailed components and structures are merely provided to assist the overall understanding of the various embodiments. Therefore, it should be apparent to those skilled in the art that various changes and modifications of the embodiments described herein may be made without departing from the scope and spirit of the present disclosure. Moreover, descriptions of well-known functions and structures are omitted for clarity and brevity. In the following drawings or in the detailed description, configurations may be connected with any other components except for components illustrated in a drawing or described in the detailed description. The terms described below are terms defined in consideration of the functions of the present disclosure and are not limited to a specific function. The definitions of the terms should be determined based on the contents throughout the specification.

Components that are described in the detailed description with reference to the terms “driver”, “block”, etc. will be implemented with software, hardware, or a combination thereof. For example, the software may be a machine code, firmware, an embedded code, and application software. For example, the hardware may include an electrical circuit, an electronic circuit, a processor, a computer, integrated circuit cores, a pressure sensor, a microelectromechanical system (MEMS), a passive element, or a combination thereof.

As used herein, ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be referenced elsewhere without an ordinal number or with a different ordinal number (e.g., “second” in the specification or another claim).

As used herein, components described as being “electrically connected” are configured such that an electrical signal can be transferred from one component to the other (although such electrical signal may be attenuated in strength as it is transferred and may be selectively transferred). Moreover, components that are “directly electrically connected” form a common electrical node through electrical connections by one or more conductors, such as, for example, wires, pads, internal electrical lines, through vias, etc. As such, directly electrically connected components do not include components electrically connected through active elements, such as transistors or diodes.

In embodiments, a controller may be provided, and the controller may be a processor (i.e., a hardware circuit), such as a microprocessor, a CPU (Central Processing Unit), a GPU (graphics processor), a digital signal processor (DSP), a field- programmable gate array (FPGA), etc., and may be part of a computer. Such a controller may be formed by several interconnected controllers and may be configured by software.

The controller may be a computer (or several interconnected computers) and may include, for example, one or more processors configured by software, such as a CPU (Central Processing Unit), GPU (graphics processor), controller, etc. The computer may be a general purpose computer or may be dedicated hardware or firmware (e.g., an electronic or optical circuit, such as application-specific hardware, such as, for example, a digital signal processor (DSP) or a field- programmable gate array (FPGA)). A computer may be configured from several interconnected computers. Each functional module (or unit) described herein may comprise a separate computer, or some or all of the functional module (or unit) may be comprised of and share the hardware of the same computer. Connections and interactions between the units described herein may be hardwired and/or in the form of data (e.g., as data stored in and retrieved from memory of the computer, such as a register, buffer, cache, storage drive, etc., such as part of an application programming interface (API)). The functional modules (or units) of the controller may each correspond to a separate segment or segments of software (e.g., a subroutine) which configure the computer of the controller, and/or may correspond to segment(s) of software that also correspond to one or more other functional modules (or units) described herein (e.g., the functional modules (or units) may share certain segment(s) of software or be embodied by the same segment(s) of software). As is understood, “software” refers to prescribed rules to operate a computer, such as code or script. Storage (e.g., storage device) may comprise conventional memory of a computer, such as a hard drive (which may be a solid state drive, DRAM, NAND flash memory, etc.). An operation unit may comprise a conventional computer user interface and include convention input devices, such as a keyboard, mouse, trackpad, touchscreen, etc.

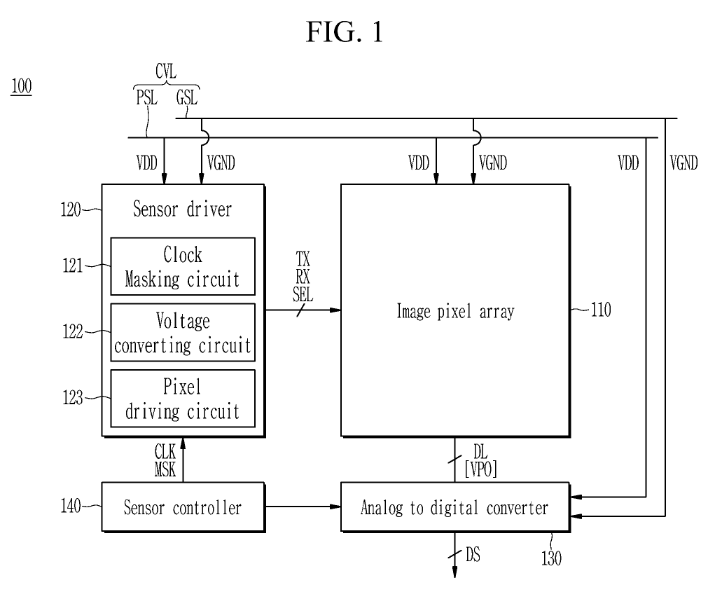

FIG. 1 is a block diagram showing a configuration of an image sensor device according to an embodiment of the present disclosure. Referring to FIG. 1, the image sensor device 100 may include a ground supply line GSL, a power supply line PSL, an image pixel array 110, a sensor driver 120, an analog-to-digital converter 130, and a sensor controller 140.

The image pixel array 110 may include a plurality of image pixels arranged in a row direction and a column direction. Each of the plurality of image pixels may generate a pixel output voltage VPO in response to control of the sensor driver 120. For example, each of the plurality of image pixels may generate a pixel reset voltage or a pixel data voltage. Each of the plurality of image pixels may provide the generated pixel output voltage VPO to a data line DL connected thereto. That is, the pixel output voltage VPO may be in the form of an analog voltage.

The sensor driver 120 may be connected to the image pixel array 110 through a plurality of signal lines. The sensor driver 120 may provide various types of pixel control signals, such as a reset signal RX, a transmission signal TX, and a select signal SEL, to each of the plurality of image pixels.

The analog-to-digital converter 130 may be connected to the image pixel array 110 through data lines DL. The analog-to-digital converter 130 may generate a digital signal DS corresponding to the pixel output voltage VPO. That is, the analog-to-digital converter 130 may convert a voltage level (e.g., analog voltage) of the data line DL to the digital signal DS, by sampling the voltage level. For example, the analog-to-digital converter 130 may generate the digital signal DS by performing a correlated double sampling (CDS) operation based on the pixel reset voltage and the pixel data voltage provided through the data line DL.

The ground supply line GSL may provide the ground voltage VGND to components of the image sensor device 100. For example, the ground supply line GSL may provide the ground voltage VGND to the image pixel array 110, the sensor driver 120, and the analog-to-digital converter 130. The power supply line PSL may provide power supply voltage VDD to each component of the image sensor device 100. For example, the power supply line PSL may provide the power supply voltage VDD to the image pixel array 110, the sensor driver 120, and the analog-to-digital converter 130. Each of the ground supply line GSL and power supply line PSL may also be referred to as a common voltage line CVL. Accordingly, when the common voltage line CVL is the power supply line PSL, then the voltage level of the common voltage line CVL is the power supply voltage. Likewise, when the common voltage line CVL is the ground supply line GSL, then the voltage level of the common voltage line CVL is the ground voltage.

The sensor controller 140 may control overall operations of the image sensor device 100. For example, the sensor controller 140 may control an operation timing of the sensor driver 120 and the analog-to-digital converter 130. The sensor controller 140 may provide a clock signal CLK and a mask signal MSK to the sensor driver 120.

It is assumed below that the sensor controller 140 provides the clock signal CLK to the sensor driver 120, but the scope of the present disclosure is not limited thereto. For example, the sensor driver 120 may be implemented to receive the clock signal CLK from any component not shown in FIG. 1, or may be implemented to receive the clock signal CLK directly from outside the image sensor device 100.

The sensor driver 120 may include a clock masking circuit 121, a voltage converting circuit 122, and a pixel driving circuit 123.

The clock masking circuit 121 may receive the clock signal CLK and the mask signal MSK. The clock masking circuit 121 may generate a masked clock signal (hereinafter, referred to as “MCLK”) by masking the clock signal CLK based on a logic level of the mask signal MSK.

In an embodiment, the masked clock signal MCLK may be a clock signal that maintains a constant logic level for a specific time period. That is, the masked clock signal MCLK may maintain the constant logic level during the specific time period and toggle during other time periods. For example, in an embodiment, when the masked clock signal MCLK toggles during other time periods, the masked clock signal MCLK may repeatedly switch between a low logic level and a high logic level.

The voltage converting circuit 122 may receive the masked clock signal MCLK. The voltage converting circuit 122 may generate a boost voltage (hereinafter referred to as “VBST”) by boosting at least one of the power supply voltage VDD and the ground voltage VGND. For example, a voltage level of the boost voltage VBST may have an absolute value (e.g., a first absolute value) that is greater than a second absolute value of a voltage level of the common voltage line CVL. For example, the voltage converting circuit 122 may generate a voltage higher than the power supply voltage VDD by over-boosting the power supply voltage VDD based on the masked clock signal MCLK, or may generate a voltage lower than the ground voltage VGND by down-boosting the ground voltage VGND based on the masked clock signal MCLK.

The pixel driving circuit 123 may control the image pixel array 110 based on the boost voltage VBST. For example, the pixel driving circuit 123 may generate various types of pixel control signals, such as the reset signal RX, the transmission signal TX, and the select signal SEL, based on the boost voltage VBST.

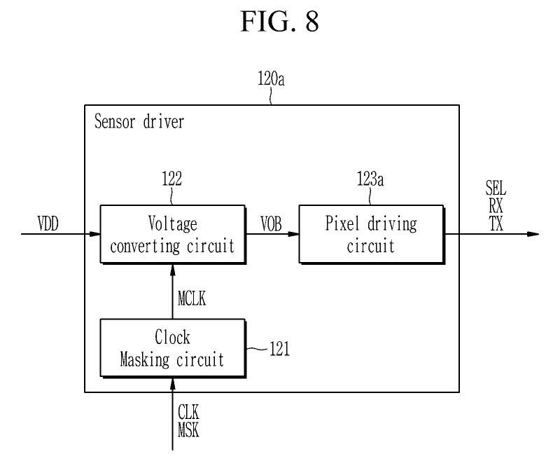

In an embodiment, the pixel driving circuit 123 may generate various types of pixel control signals based on the boost voltage VBST. An embodiment in which the pixel driving circuit 123 generates a pixel control signal based on the boost voltage VBST is described in more detail with reference to FIG. 8 below.

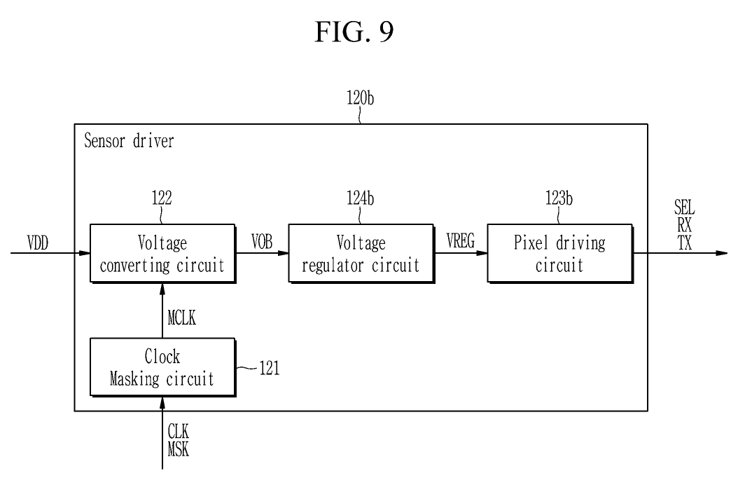

In an embodiment, a voltage regulator circuit (not shown) may generate a regulated voltage by regulating the boost voltage VBST, and the pixel driving circuit 123 may generate various types of pixel control signals based on the regulated voltage. An embodiment in which the pixel driving circuit 123 generates the pixel control signals based on a regulated voltage is described in more detail with reference to FIG. 9 below.

The voltage converting circuit 122 may boost at least one of the power supply voltage VDD and the ground voltage VGND based on toggling of the masked clock signal MCLK. For example, the voltage converting circuit 122 may boost at least one of the power supply voltage VDD and the ground voltage VGND by repeatedly connecting and disconnecting some circuit elements to the common voltage line CVL based on toggling of the masked clock signal MCLK. In this case, noise may occur in the voltage level of the common voltage line CVL due to such connections and disconnections. For example, the voltage level of the common voltage line CVL (e.g., power supply voltage VDD or ground voltage VGND) may rise and fall little by little repeatedly rather than being maintained at a constant voltage level. For example, due to the operation of the voltage converting circuit 122, ripples may occur in the voltage level of the power supply voltage VDD or the ground voltage VGND.

When noise occurs in the voltage level of the common voltage line CVL, noise may also occur in the digital signal DS which is generated from the image sensor device 100. As such, noise may also occur in an image generated based on the digital signal DS.

According to an embodiment of the present disclosure, the clock masking circuit 121 may maintain the logic level of the masked clock signal MCLK constantly, during a time period that significantly affects the value of the digital signal DS. For example, during such a time period, noise on the voltage line of the common voltage line CVL due to the operation of the voltage converting circuit 122 may be minimized by maintaining the constant logic level of the masked clock signal MCLK during this time period. Therefore, according to an embodiment of the present disclosure, an image may be generated based on the image sensor device 100 with noise being minimized.

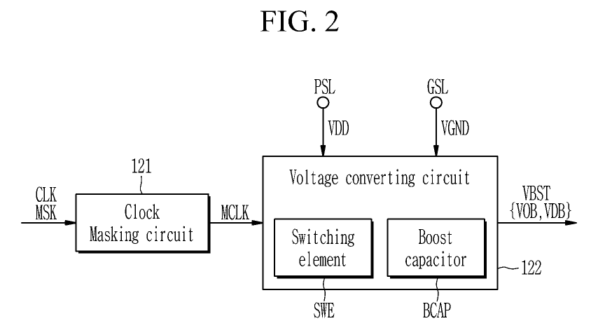

FIG. 2 is a block diagram showing some of the components of FIG. 1 in more detail. Referring to FIGS. 1 and 2, the clock masking circuit 121 may receive the clock signal CLK and the mask signal MSK from the sensor controller 140 (e.g., illustrated in FIG. 1). The clock signal CLK may be a signal that repeats transitions between logic low and logic high with regular time intervals. The mask signal MSK may be a signal that has a first logic level (e.g., logic high) for a specific time period and a has second logic level (e.g., logic low) for other time periods.

The clock masking circuit 121 may generate the masked clock signal MCLK by masking the clock signal CLK based on the logic level of the mask signal MSK. For example, the clock masking circuit 121 may maintain the logic level of the masked clock signal MCLK constantly while the mask signal MSK has the first logic level, and may set the logic level of the masked clock signal MCLK to be same as the logic level of the clock signal CLK while the mask signal MSK has the second logic level. For example, the clock masking circuit 121 may receive the clock signal CLK and the mask signal MSK, and may generate the masked clock signal MCLK based on the logic level of the clock signal CLK and the mask signal MSK. For example, when the mask signal MSK has the first logic level (e.g., logic high), the clock masking circuit 121 may generate the masked clock signal MCLK having a constant logic level (e.g., constantly logic low or constantly logic high) for the duration of a first time period during which the mask signal MSK has the first logic level. When the mask signal MSK has the second logic level (e.g., logic low), the clock masking circuit 121 may generate the masked clock signal MCLK having the same logic level as the clock signal CLK for the duration of a second time period during which the mask signal MSK has the second logic level.

The voltage converting circuit 122 may receive the masked clock signal MCLK from the clock masking circuit 121. The voltage converting circuit 122 may be connected to at least one of the power supply line PSL and the ground supply line GSL. The voltage converting circuit 122 may generate the boost voltage VBST by boosting at least one of the power supply voltage VDD and the ground voltage VGND based on the masked clock signal MCLK. For example, the voltage converting circuit 122 may generate an overboost voltage VOB that is higher than the power supply voltage VDD or a downboost voltage VDB that is lower than the ground voltage VGND.

An example in which the voltage converting circuit 122 generates the boost voltage VBST with a charge pump scheme is described below as a representative example. However, the scope of the present disclosure is not limited thereto, and the voltage converting circuit 122 may be implemented as any type of voltage converting circuit, such as an inductor-based boost converter, a flyback converter, a buck-boost converter, etc.

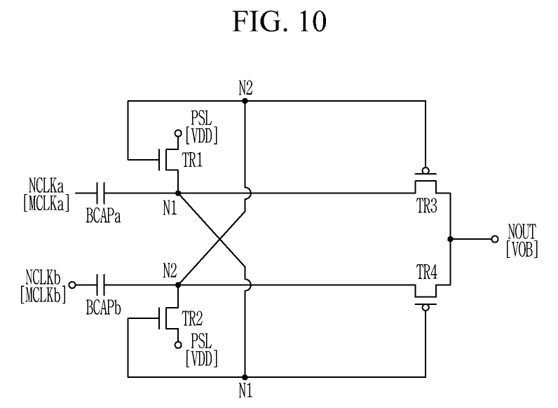

The voltage converting circuit 122 may include a switching element SWE (e.g., a switching circuit) and a boost capacitor BCAP. The voltage converting circuit 122 may charge the boost capacitor BCAP, and may generate the boost voltage VBST based on charges of the boost capacitor BCAP. For this operation, the switching element SWE may repeat the operation of connecting and disconnecting the boost capacitor BCAP to and from the power supply line PSL or the operation of connecting and disconnecting the boost capacitor BCAP to and from the ground supply line GSL, according to the logic level of the masked clock signal MCLK. In this case, noise may occur in the voltage level of the power supply line PSL or the ground supply line GSL according to the logic level transition of the masked clock signal MCLK. An example how the voltage converting circuit 122 generates the boost voltage VBST based on the switching element SWE and the boost capacitor BCAP is described in more detail with reference to FIG. 10 below. Accordingly, and as described below in FIG. 10, the switching element SWE may electrically connect and disconnect the boost capacitor BCAP to and from the common voltage line (e.g., the power supply line PSL or the ground supply line GSL) based on the logic level of the masked clock signal MCLK.

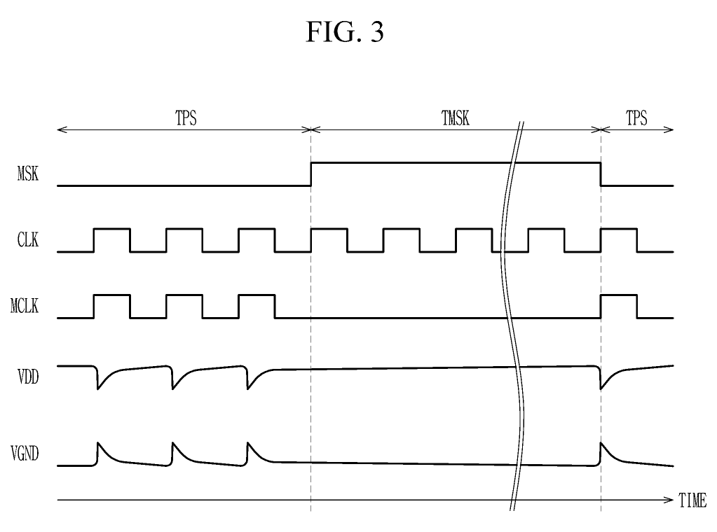

FIG. 3 is a diagram showing a relationship between the mask signal MSK, the power supply voltage VDD and ground voltage VGND in FIG. 2. The horizontal axis of FIG. 3 may represent time, and the vertical axis may represent voltage level.

Referring to FIGS. 1-3, the mask signal MSK may have the first logic level (e.g., logic high) during a masking period TMSK, and the mask signal MSK may have the second logic level (e.g., logic low) during a pass period TPS. The clock signal CLK may toggle with regular intervals regardless of, and during, the pass period TPS and masking period TMSK, with the clock signal CLK toggling between a low logic level and a high logic level.

The masked clock signal MCLK may have a constant logic level during the masking period TMSK. For example, the masked clock signal MCLK may be held at a logic low level during the masking period TMSK. FIG. 3 illustrates an embodiment in which the masked clock signal MCLK maintains the logic low level during the masking period TMSK, but the scope of the present disclosure is not limited thereto. For example, the masked clock signal MCLK may be maintained at a logic high level during the masking period TMSK.

Also, although it is assumed below that the mask signal MSK is at logic high during the masking period TMSK and at logic low during the pass period TPS, the scope of the present disclosure is not limited thereto. For example, the mask signal MSK may be at logic low during the masking period TMSK and at logic high during the pass period TPS. That is, the scope of the present disclosure is not limited to a specific logic level of the mask signal MSK.

In an embodiment, a length of the masking period TMSK may be longer than a period of the clock signal CLK. For example, the clock signal CLK may toggle between the low logic level and the high logic level during the masking period TMSK.

The masked clock signal MCLK may toggle between logic levels during the pass period TPS. For example, the masked clock signal MCLK may repeatedly transition between the logic low level and the logic high level during the pass period TPS.

In an embodiment, during the pass period TPS, the clock masking circuit 121 may pass or use the clock signal CLK as the masked clock signal MCLK, for example, with the masked clock signal MCLK being equivalent (e.g., the same logic level at the same time for the same duration, etc.) to the clock signal CLK. In this case, the logic level of the masked clock signal MCLK during the pass period TPS may be same as the logic level of the clock signal CLK. However, the scope of the present disclosure is not limited thereto.

The voltage converting circuit 122 may operate in response to the masked clock signal MCLK. For example, the switching element SWE may be connected to the common voltage line CVL. The switching element SWE may be implemented to be turned on in response to the masked clock signal MCLK being at logic high and turned off in response to the masked clock signal MCLK being at logic low; or may be implemented to be turned on in response to the masked clock signal MCLK being at logic low and turned off in response to the masked clock signal MCLK being at logic high. In this case, noise may occur in the voltage level of the common voltage line CVL during the pass period TPS. For example, if the switching element SWE is connected to the power supply line PSL, noise may occur in the power supply voltage VDD. If the switching element SWE is connected to the ground supply line GSL, noise may occur in the ground voltage VGND. On the other hand, since the logic level of the masked clock signal MCLK does not change during the masking period TMSK, the switching element SWE may maintain one of a turn-on state or a turn-off state due to the masked clock signal MCLK being at a constant logic level during the masking period TMSK. In this case, noise may not occur in the voltage level of the common voltage line CVL (i.e., the power supply voltage VDD or ground voltage VGND).

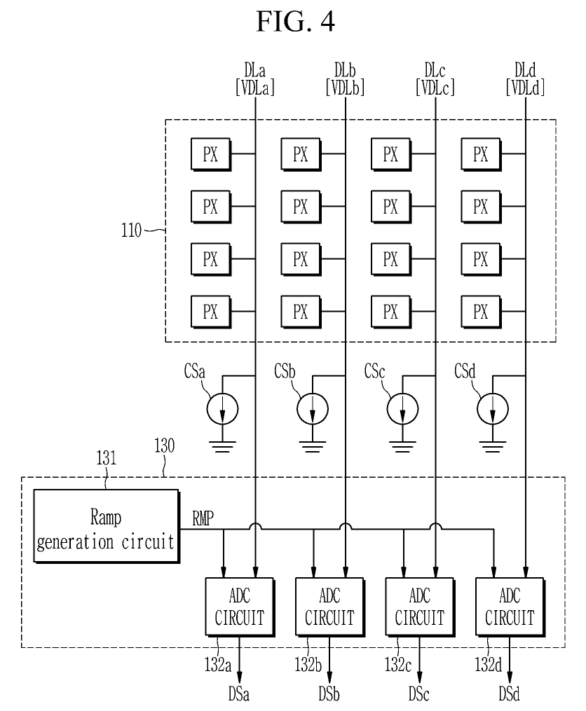

FIG. 4 is a block diagram showing a part of the configuration of the image sensor device of FIG. 1 in more detail. Below, some configurations of the image sensor device 100 are illustrated, but the scope of the present disclosure is not limited thereto. In addition, although FIG. 2 illustrates that a plurality of image pixels PX are arranged along first to fourth pixel rows and first to fourth pixel columns of the image pixel array 110, the scope of the present invention is not limited thereto. For example, the image pixel array 110 may be expanded in row direction or column direction, and a plurality of image pixels may be further included in the image pixel array 110.

Referring to FIGS. 1-4, the image sensor device 100 may include the image pixel array 110 and the analog-to-digital converter 130. The image pixel array 110 may include a plurality of image pixels PX. Among the plurality of image pixels PX, image pixels positioned in a first pixel column may be connected to a first data line DLa, image pixels positioned in a second pixel column may be connected to a second data line DLb, image pixels positioned in a third pixel column may be connected to a third data line DLc, and image pixels positioned in a fourth pixel column may be connected to a fourth data line DLd. The voltage levels of the first to fourth data lines DLa to DLd may be referred to as the first to fourth data line voltages VDLa to VDLd, respectively.

In an embodiment, image pixels included in same pixel row within the image pixel array 110 may be connected to the sensor driver 120 through the same signal lines. That is, image pixels included in the same pixel row may share signal lines. Accordingly, image pixels PX included in the same pixel row may receive the same pixel control signals from the sensor driver 120. For example, image pixels PX included in the first pixel row may share a reset signal RX, a transmission signal TX, and a select signal SEL.

Each of the plurality of image pixels PX may generate a pixel output voltage VPO based on the reset signal RX and the transmission signal TX. Each of the plurality of image pixels PX may output the pixel output voltage VPO to a data line DL in response to the select signal SEL. In this case, each data line voltage VDL may be determined based on a voltage level of the pixel output voltage VPO.

In an embodiment, the pixel output voltage VPO output by each of the image pixels PX may be a pixel reset voltage generated based on a reset operation, or may be a pixel data voltage generated based on a transfer operation.

First to fourth current sources CSa to CSd may be connected to the first to fourth data lines DLa to DLd, respectively. Each of the first to fourth current sources CSa to CSd may be a constant current source. However, the scope of the present disclosure is not limited to the implementation method of the first to fourth current sources CSa to CSd.

The analog-to-digital converter 130 may include a ramp generation circuit 131 and first to fourth analog-to-digital converting (ADC) circuits 132a to 132d.

Each of the first to fourth ADC circuits 132a to 132d may correspond to a different pixel column. For example, the first to fourth analog-to-digital conversion circuits 132a to 132d may be connected to the first to fourth data lines DLa to DLd, respectively.

The ramp generation circuit 131 may generate a ramp signal RMP. The ramp generation circuit 131 may provide the ramp signal RMP to each of the first to fourth ADC circuits 132a to 132d.

In an embodiment, the ramp signal RMP may be a signal whose voltage level decreases linearly in a predetermined time period. However, the scope of the present disclosure is not limited to a specific implementation method of the ramp signal RMP. For example, the ramp signal RMP may be implemented as a signal whose voltage level increases linearly in the predetermined time period.

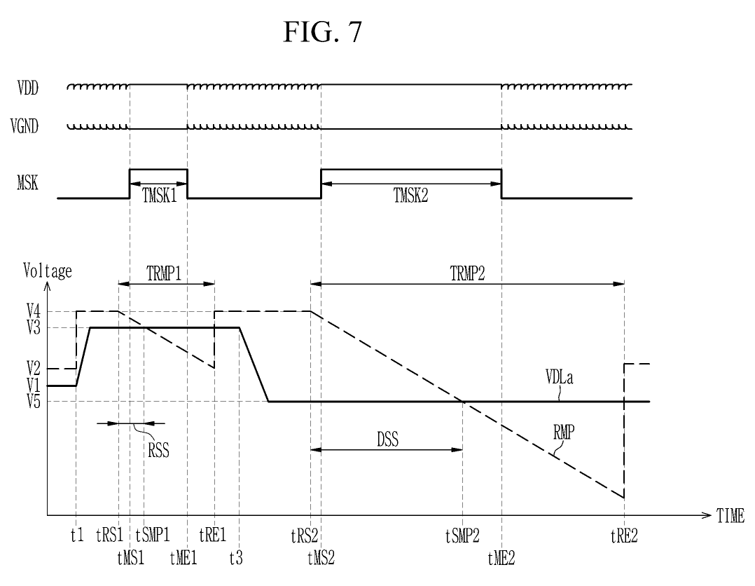

The first to fourth ADC circuits 132a to 132d may respectively generate first to fourth digital signals DSa to DSd, by comparing voltage levels of the ramp signal RMP and data line voltage VDL of the data line DL connected thereto. For example, the ramp signal RMP may be used as a reference voltage for the first to fourth data line voltages VDLa to VDLd. For example, the first ADC circuit 132a may output the first digital signal DSa by comparing the voltage levels of the first data line voltage VDLa and the ramp signal RMP. More detailed operation of the ADC circuit 132 is described in more detail with reference to FIG. 7 below.

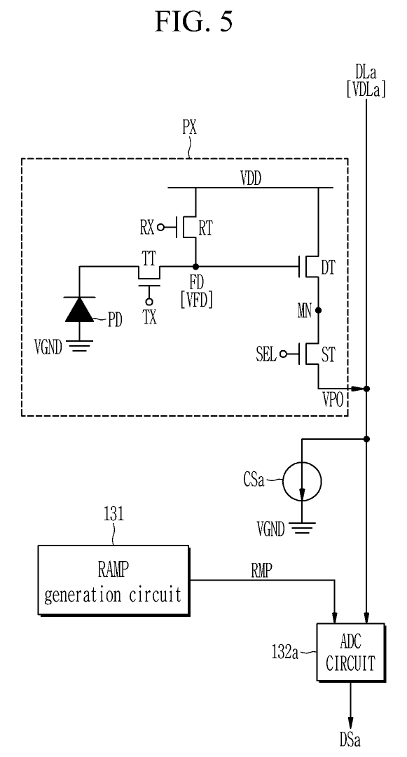

FIG. 5 is a drawing showing some of the configurations of FIG. 4 in more detail. Hereinafter, with reference to FIG. 4, the operation of the image sensor device 100 for the first pixel column will be described in more detail.

Additionally, it is assumed below that the image pixel PX has a 4TR-1PD (4-transistor, 1-photodiode) structure. However, the scope of the present disclosure is not limited thereto, and each of the image pixels PX included in the image pixel array 110 may be implemented in various forms, such as a 5TR-2PD (5-transistor, 2-photodiode) structure, a 6TR-3PD (6-transistor, 3-photodiode) structure, etc.

The image pixel PX may receive the power supply voltage VDD from the power supply line PSL and may receive the ground voltage VGND from the ground supply line GSL.

The image pixel PX may provide a pixel output voltage VPO to the first data line DLa in response to a reset signal RX, a transmission signal TX, and a select signal SEL.

The image pixel PX may include a photodiode PD, a transmission transistor TT, a reset transistor RT, a drive transistor DT, and a select transistor ST. The photodiode PD may generate charges (e.g., convert photons into electrons) based on light from outside.

The transmission transistor TT may be connected between the photodiode PD and a floating diffusion node FD. The transmission transistor TT may operate in response to the transmission signal TX from the sensor driver 120. For example, the transmission transistor TT may be turned on in response to the transmission signal TX. In this case, since charges may move from the photodiode PD to the floating diffusion node FD, the voltage level of the floating diffusion node FD may be lowered. Hereinafter, the voltage level of the floating diffusion node FD is referred to as a 'floating diffusion voltage VFD'.

The reset transistor RT may be connected between the power supply voltage VDD and the floating diffusion node FD. The reset transistor RT may operate in response to the reset signal RX provided from the sensor driver 120. For example, the reset transistor RT may be turned on in response to the reset signal RX. In this case, the floating diffusion voltage VFD may increase based on the power supply voltage VDD.

The drive transistor DT may be connected between the power supply voltage VDD and the middle node MN. The drive transistor DT may operate in response to the floating diffusion voltage VFD. For example, a gate terminal of the drive transistor DT may be connected to the floating diffusion node FD. The drive transistor DT may generate the pixel output voltage VPO based on the floating diffusion voltage VFD. That is, the drive transistor DT may operate as a source follower whose input terminal is connected to the floating diffusion node FD. The drive transistor DT may provide the pixel output voltage VPO to the middle node MN.

The select transistor ST may be connected between the middle node MN and the first data line DLa. The select transistor ST may operate in response to the select signal SEL. For example, the select transistor ST may be turned on in response to the select signal SEL. In this case, the voltage level of the first data line voltage VDLa may be determined based on the pixel output voltage VPO.

In an embodiment, an operation of charging the floating diffusion node FD based on the power supply voltage VDD may be referred to as a reset operation.

In an embodiment, an operation of decreasing the floating diffusion voltage VFD by transferring charges from the photodiode PD to the floating diffusion node FD may be referred to as a transfer operation.

In an embodiment, a pixel output voltage VPO generated by the drive transistor DT based on a voltage of the floating diffusion node FD charged by the reset operation may be referred to as a 'pixel reset voltage'.

In an embodiment, a pixel output voltage VPO generated by the drive transistor DT based on a voltage of the floating diffusion node FD decreased by the transfer operation may be referred to as a 'pixel data voltage'.

At least one of the image pixel PX, the first current source CSa, and the ramp generation circuit 131 may be connected to the power supply line PSL. For example, each of the image pixel PX, the first current source CSa, and the ramp generation circuit 131 may receive the power supply voltage VDD from the power supply line PSL. Accordingly, when noise occurs in the power supply voltage VDD provided from the power supply line PSL, noise may also occur in the ramp signal RMP and the first data line voltage VDLa. In this case, noise may also be included in the first digital signal DSa generated based on the ramp signal RMP and the first data line voltage VDLa.

Similarly, at least one of the image pixel PX, the first current source CSa, and the ramp generation circuit 131 may be connected to the ground supply line GSL. For example, each of the image pixel PX, the first current source CSa, and the ramp generation circuit 131 may receive the ground voltage VGND from the ground supply line GSL. Accordingly, when noise occurs in the ground voltage VGND provided from the ground supply line GSL, noise may also occur in the ramp signal RMP and the first data line voltage VDLa. In this case, noise may also be included in the first digital signal DSa generated based on the ramp signal RMP and the first data line voltage VDLa.

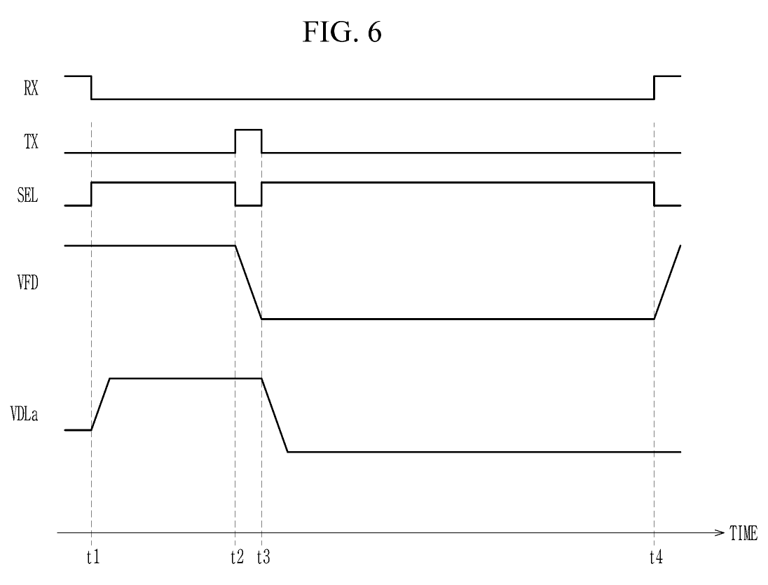

FIG. 6 is a timing diagram showing an operation of the image sensor device of FIG. 5. The horizontal axis of FIG. 6 may represent time, and the vertical axis may represent voltage level. Referring to FIGS. 1-6, a reset operation for the image pixel PX may be performed before a first time point t1. For example, prior to the first time point t1, the reset signal RX may be at a logic high and the select signal SEL may be at a logic low. In this case, the reset transistor RT may be turned on in response to the reset signal RX, and the floating diffusion voltage VFD may rise to a level corresponding to the power supply voltage VDD.

Between the first time point t1 and the second time point t2, the analog-to-digital converter 130 may perform a reset sampling operation. For example, between the first time point t1 and the second time point t2, the reset signal RX may be at a logic low and the select signal SEL may be at a logic high. The image pixel PX may provide the pixel output voltage VPO to the first data line DLa in response to the select signal SEL. In this case, the pixel output voltage VPO provided from the image pixel PX to the first data line DLa may be a pixel reset voltage. The first ADC circuit 132a may identify (e.g., sample) the first data line voltage VDLa (i.e., pixel reset voltage) between the first time point t1 and the second time point t2 based on the ramp signal RMP. For example, the first ADC circuit 132a may convert the first data line voltage VDLa (e.g., the pixel output voltage VPO or pixel reset voltage) to the first digital signal DSa by comparing the first data line voltage VDLa to the ramp signal RMP between the first time point t1 and the second time point t2. As described below relative to FIG. 7, this comparison may include identifying when the first data line voltage VDLa is equal to a voltage of the ramp signal RMP.

Between the second time point t2 and the third time point t3, the image pixel PX may perform a transfer operation. For example, between the second time point t2 and the third time point t3, the transmission signal TX may be at a logic high and the select signal SEL may be at a logic low. In this case, the floating diffusion voltage VFD may be decreased by charges of the photodiode PD.

Between the third time point t3 and the fourth time point t4, the analog-to-digital converter 130 may perform a data sampling operation. For example, between the third time point t3 and the fourth time point t4, the transmission signal TX may be at a logic low and the select signal SEL may be at a logic high. The image pixel PX may provide the pixel output voltage VPO to the first data line DLa in response to the select signal SEL. In this case, the pixel output voltage VPO provided by the image pixel PX to the first data line DLa may be a pixel data voltage. The first ADC circuit 132a may identify (e.g., sample) the first data line voltage VDLa (i.e., pixel data voltage) between the third time point t3 and the fourth time point t4 based on the ramp signal RMP. For example, the first ADC circuit 132a may convert the first data line voltage VDLa (e.g., the pixel output voltage VPO or pixel data voltage) to the first digital signal DSa by comparing the first data line voltage VDLa to the ramp signal RMP between the third time pointt3 and the fourth time point t4. As described below relative to FIG. 7, this comparison may include identifying when the first data line voltage VDLa is equal to a voltage of the ramp signal RMP.

In an embodiment, the first ADC circuit 132a may generate a first digital signal DSa based on a difference between a pixel reset voltage sampled between the first and second time points t1, t2 and a pixel data voltage sampled between the third and fourth time points t3, t4.

After the fourth time point t4, the sensor driver 120 may perform a reset operation for the image pixel PX. In this case, the floating diffusion voltage VFD may rise to a level corresponding to the power supply voltage VDD.

FIG. 7 is a diagram showing how the sensor controller of FIG. 1 controls the mask signal. The horizontal axis of FIG. 7 may represent time, and the vertical axis may represent voltage level. Hereinafter, with reference to FIGS. 1-7, a method illustrating how the sensor controller 140 controls the mask signal MSK while the first ADC circuit 132a generates the first digital signal DSa will be described. However, the scope of the present disclosure is not limited thereto.

Prior to the first time point t1, a reset operation for the image pixel PX may be performed. Before the first time point t1, the first data line voltage VDLa (e.g., illustrated with a solid line labeled VDLa) may be a first voltage V1 and the ramp signal RMP (e.g., illustrated with a dashed line labeled RMP) may be a second voltage V2. However, the scope of the present disclosure is not limited to specific voltage levels of the first data line voltage VDLa and the ramp signal RMP before the first time point t1.

After the first time point t1, as the select signal SEL transitions to logic high (e.g., from t1 to t2 in FIG. 6), the first data line voltage VDLa may rise to the third voltage V3. The third voltage V3 may correspond to a pixel reset voltage, which is the voltage at which the first data line voltage VDLa and the voltage level of the ramp signal RMP are equal to each other after the first time point t1 (e.g., at first sampling time point tSMP1).

In an embodiment, the voltage level of the ramp signal RMP may rise to a fourth voltage V4 at the first time point t1. However, the scope of the present disclosure is not limited to a specific time point when the voltage level of the ramp signal RMP rises. In embodiments, and as illustrated in FIG. 7, the fourth voltage V4 may be greater than the third voltage V3.

The voltage level of the ramp signal RMP may remain at the fourth voltage V4 from the first time point t1 to a first ramp start time point tRS1, and then may decrease linearly between the first ramp start time point tRS1 and a first ramp end time point tRE1. The time period between the first ramp start time point tRS1 and the first ramp end time point tRE1 may be referred to as a first ramp period TRMP1. After the first ramp end time point tRE1, the voltage level of the ramp signal RMP may rise again to the fourth voltage V4.

In an embodiment, the first ramp start time point tRS1 may be a later time point than the first time point t1. The first ramp end time point tRE1 may be an earlier time point than the second time point t2 and the third time point t3.

The first ADC circuit 132a may sample the voltage level of the first data line voltage VDLa between the first time point t1 and the third time point t3 based on the voltage level of the ramp signal RMP. For example, the voltage level of the ramp signal RMP and the voltage level of the first data line voltage VDLa may be equal to each other at a first sampling time point tSMP1, for example, with the voltage level of the ramp signal RMP and the voltage level of the first data line voltage VDLa both at the third voltage V3 at the first sampling time point tSMP1. The first ADC circuit 132a may identify a time interval (hereinafter referred to as a reset sampling time interval RSS) between the first ramp start time point tRS1 and the first sampling time point tSMP1. For example, the first ADC circuit 132amay identify the pixel reset voltage associated with the reset sampling time interval RSS. In embodiments, the reset sampling time interval RSS may represent the time interval during which the ramp signal RMP begins to decrease from the fourth voltage V4 until reaching the same voltage level as the first data line voltage VDLa (e.g., the third voltage V3).

After the third time point t3, as the select signal SEL transitions to logic high (e.g., illustrated at time point t3 in FIG. 6), the first data line voltage VDLa may decrease to the fifth voltage V5, with the first data line voltage VDLa beginning to decrease starting at the third time point t3 and decreasing until reaching the fifth voltage V5. The fifth voltage V5 may correspond to the pixel data voltage.

After the voltage level of the ramp signal RMP increases to the fourth voltage V4 at the first ramp end time point tRE1 and remains at the fourth voltage V4 until a second ramp start time point tRS2, the voltage level of the ramp signal RMP may decrease linearly between the second ramp start time point tRS2 and the second ramp end time point tRE2. The time period between the second ramp start time point tRS2 and the second ramp end time point tRE2 may be referred to as a second ramp period TRMP2. After the second ramp end time point tRE2, the voltage level of the ramp signal RMP may rise to the second voltage V2.

In an embodiment, the second ramp start time point tRS2 may be a later time point than the third time point t3. The second ramp end time point tRE2 may be an earlier time point than the fourth time point t4 (e.g., illustrated in FIG. 6).

The first ADC circuit 132a may sample the voltage level of the first data line voltage VDLa between the third time point t3 and the fourth time point t4 based on the voltage level of the ramp signal RMP. For example, the voltage level of the ramp signal RMP and the voltage level of the first data line voltage VDLa may be equal to each other at a second sampling time point tSMP2, for example, with the voltage level of the ramp signal RMP and the voltage level of the first data line voltage VDLa both at the fifth voltage V5 at the second sampling time point tSMP2. The first ADC circuit 132a may identify a time interval (hereinafter referred to as a data sampling time interval DSS) between the second ramp start time point tRS2 and the second sampling time point tSMP2. For example, the first ADC circuit 132a may identify the pixel data voltage based on the data sampling time interval DSS. In embodiments, the data sampling time interval DSS may represent the time interval during which the ramp signal RMP begins to decrease from the fourth voltage V4 until reaching the same voltage level as the first data line voltage VDLa (e.g., the fifth voltage V5).

The first ADC circuit 132a may generate a first digital signal DSa corresponding to a difference between the identified pixel reset voltage (e.g., the third voltage V3) and the pixel data voltage (e.g., the fifth voltage V5). For example, the first ADC circuit 132a may generate the first digital signal DSa having a code value corresponding to the difference between the reset sampling time interval RSS and the data sampling time interval DSS. For example, the time difference between the reset sampling time interval RSS and the data sampling time interval DSS correlates to the voltage difference between the identified pixel reset voltage and the pixel data voltage, and the first ADC circuit 132a may convert this time difference into the code value representing the intensity of light that is provided to the image pixels.

The sensor controller 140 may set a first masking period TMSK1 and a second masking period TMSK2 to minimize the influence of noise on the common voltage line CVL for the first digital signal DSa. For example, the sensor controller 140 may set the mask signal MSK to logic high during the first masking period TMSK1 and the second masking period TMSK2. In this case, the noise of the power supply voltage VDD and the ground voltage VGND may be minimized during the first masking period TMSK1 and the second masking period TMSK2. For example, the power supply voltage VDD and the ground voltage VGND may be maintained at a constant voltage level during the first masking period TMSK1 and the second masking period TMSK2. As illustrated in FIG. 7, the voltage levels of the power supply voltage VDD and the ground voltage VGND are constant during the first masking period TMSK1 and the second masking period TMSK2, and are not constant outside of the first masking period TMSK1 and the second masking period TMSK2.

More specifically, the influence of noise of the common voltage line CVL for the first digital signal DSa may be greatest at the first sampling time point tSMP1 and the second sampling time point tSMP2. Accordingly, when the lengths of the first masking period TMSK1 and the second masking period TMSK2 are set sufficiently long so that the first sampling time point tSMP1 and the second sampling time point tSMP2 are included in the first masking period TMSK1 and the second masking period TMSK2, respectively, the influence of noise of the common voltage line CVL for the first digital signal DSa may be minimized. However, as the lengths of the first masking period TMSK1 and the second masking period TMSK2 increase, a possibility of errors occurring in the operation of components of the image sensor device 100 that operate based on the boost voltage VBST may increase. Accordingly, the sensor controller 140 may determine the first masking period TMSK1 and the second masking period TMSK2 so as to minimize the influence of noise of the common voltage line CVL for the first digital signal DSa, while also minimizing the possibility of errors occurring in the operation of components of the image sensor device 100 that operate based on the boost voltage VBST.

For a more detailed example, the sensor controller 140 may set the first masking period TMSK1 to be included in, and at least partially overlap with, the first ramp period TRMP1 and may set the second masking period TMSK2 to be included in, and at least partially overlap with, the second ramp period TRMP2. For example, the first masking period TMSK1 may occur within the first ramp period TRMP1, with the first masking period TMSK1 overlapping the first sampling time point tSMP1. In addition, the second masking period TMSK2 may occur within the second ramp period TRMP2, with the second masking period TMSK2 overlapping the second sampling time point tSMP2. The sensor controller 140 may set the length of the first masking period TMSK1 to be shorter than the length of the second masking period TMSK2 due to the reset sampling time interval RSS being shorter in duration than the data sampling time interval DSS.

A start time of the first masking period TMSK1 may be referred to as a first masking start time point tMS1, and an end time of the first masking period TMSK1 may be referred to as the first masking end time point tME1. A start time of the second masking period TMSK2 may be referred to as a second masking start time point tMS2, and an end time of the second masking period TMSK2 may be referred to as a second masking end time point tME2.

Each of a time interval between the first ramp start time point tRS1 and the first masking start time point tMS1, and a time interval between the second ramp start time point tRS2 and the second masking start time point tMS2 may be referred to as ‘a pre-masking interval’. Each of a time interval between the first masking end time point tME1 and the first ramp end time point tRE1, and a time interval between the second masking end time point tME2 and the second ramp end time point tRE2 may be referred to as ‘a post-masking interval’.

The sensor controller 140 may set the pre-masking interval before the first masking period TMSK1 so that the first sampling time point tSMP1 is a time point after the first masking start time point tMS1, and may set the pre-masking interval before the second masking period TMSK2 so that the second sampling time point tSMP2 is a time point after the second masking start time point tMS2.

In embodiments, even if the noise of the common voltage line CVL has a large effect on the first digital signal DSa, when the digital signal DS has a high code value (for example, when the photodiode PD is directly exposed to a strong light source such as sunlight), the noise in the image generated based on the digital signal DS may be difficult to be recognized by human eyes. Accordingly, the sensor controller 140 may set the length of the second masking period TMSK2 to be short (for example, determining the second masking end time tME2 to be significantly earlier than the second ramp end time point tRE2), and therefore the second masking end time point tME2 may be earlier (e.g., lead) than the second sampling time point tSMP2. In other words, the sensor controller 140 may determine the post-masking interval for the second masking period TMSK2 to be a sufficiently large value. For example, the length of the pre-masking interval for the second masking period TMSK2 may be shorter than the post-masking interval for the second masking period TMSK2. However, the scope of the present disclosure is not limited thereto.

In an embodiment, during the first masking period TMSK1 and the second masking period TMSK2, the sensor controller 140 may control the sensor driver 120 to maintain the reset signal RX, the transmission signal TX, and the select signal SEL with constant levels.

For example, according to an embodiment of the present disclosure, the mask signal MSK may have the first logic level (e.g., be activated and at a high logic level) during a time period where the noise of the common voltage line CVL has great influence on the first digital signal DSa. In embodiments, by providing the mask signal MSK at the first logic level, noise of the power supply voltage VDD and ground voltage VGND may be minimized, so the noise component of the first digital signal DSa may be minimized.

In an embodiment, image pixels PX located in one pixel row may share pixel control signals (e.g., a reset signal RX, a transmission signal TX, and a select signal SEL). Accordingly, noise components present in the common voltage line CVL may simultaneously affect image pixels PX located in one pixel row, and thus horizontal noise may occur in image generated based on the digital signals DS corresponding to the image pixels PX. However, according to an embodiment of the present disclosure, since the noise component of the common voltage line CVL is minimized, the horizontal noise of the image generated by the image sensor device 100 may be minimized.

In an embodiment, ADC circuits 132 corresponding to different pixel columns may receive ramp signals RMP having slightly different voltage levels according to distances from the ramp generation circuit 131. For example, the first ramp start time point tRS1 corresponding to each of the first to fourth ADC circuits 132a to 132d may correspond to different time points from each other. As such, even if the same intensity of light has been provided to the image pixels corresponding to different pixel columns, the first to fourth ADC circuits 132a to 132d may sample the first to fourth data line voltages VDLa to VDLd at different time points, and accordingly, the first to fourth digital signals DSa to DSd may include noise components of the common voltage line CVL of different time points each other. Accordingly, column noise may occur in the image generated by the image sensor device 100. However, according to an embodiment of the present disclosure, the noise component of the common voltage line CVL is minimized, so that the column noise of the image generated by the image sensor device 100 may be minimized.

In an embodiment, even if an intensity of light provided to one image pixel PX maintains for several frames, if noise exists in the power supply voltage VDD or the ground voltage VGND, a noise component may also be included in digital signals DS generated based on pixel output voltages VPO output from the image pixel PX. In this case, temporal noise may occur in an image generated by the image sensor device 100. However, according to an embodiment of the present disclosure, since the noise component of the common voltage line CVL is minimized, the temporal noise of the image generated by the image sensor device 100 may be minimized.

FIG. 8 is a block diagram showing a configuration of the sensor driver of FIG. 1 according to an embodiment. Referring to FIGS. 1-8, the sensor driver 120 of FIG. 1 may be implemented as a sensor driver 120a. The pixel driving circuit 123 of FIG. 1 may be implemented as a pixel driving circuit 123a.

The sensor driver 120a may include the clock masking circuit 121, the voltage converting circuit 122, and the pixel driving circuit 123a. The clock masking circuit 121 may generate the masked clock signal MCLK based on the clock signal CLK and the mask signal MSK. The voltage converting circuit 122 may generate the overboost voltage VOB based on the power supply voltage VDD.

The pixel driving circuit 123a may generate one or more of various types of pixel control signals, such as the reset signal RX, the transmission signal TX, and the select signal SEL, based on the overboost voltage VOB. For example, the pixel driving circuit 123a may be implemented to generate the pixel control signals based on the overboost voltage VOB.

In an embodiment, the pixel control signals generated by the pixel driving circuit 123a may have voltage levels higher than the power supply voltage VDD and equal to or lower than the overboost voltage VOB.

In an embodiment, when the pixel driving circuit 123a is implemented to generate various types of pixel control signals, such as the reset signal RX, the transmission signal TX, and the select signal SEL, the pixel driving circuit 123a may maintain the logic levels of the corresponding pixel control signals during the masking periods TMSK. For example, the pixel driving circuit 123a may not change logic levels of the reset signal RX, the transmission signal TX, and the select signal SEL during the masking periods TMSK. For example, even if the voltage level of the overboost voltage VOB decreases during the masking period TMSK, a probability that an error occurs in the operation of the image sensor device 100 due to transitions of the logic levels of the reset signal RX, the transmission signal TX, and the select signal SEL may be minimized. However, the scope of the present disclosure is not limited thereto, and the pixel driving circuit 123a may also be implemented to transition (e.g., lower) the logic level of the pixel control signal during the masking periods TMSK.

FIG. 9 is a block diagram showing a configuration of the sensor driver of FIG. 1 according to an embodiment. Referring to FIGS. 1 - 9, the sensor driver 120 of FIG. 1 may be implemented as a sensor driver 120b. The pixel driving circuit 123 of FIG. 1 may be implemented as a pixel driving circuit 123b.

The sensor driver 120b may include the clock masking circuit 121, the voltage converting circuit 122, the pixel driving circuit 123b, and a voltage regulator circuit 124b. Below, the differences between the sensor driver 120a and the sensor driver 120b will be explained.

The voltage regulator circuit 124b may receive the overboost voltage VOB. The voltage regulator circuit 124b may generate a regulated voltage VREG by regulating the overboost voltage VOB.

In an embodiment, the voltage regulator circuit 124b may be implemented as a low-dropout (LDO) regulator circuit. For example, the regulated voltage VREG may be equal to or lower than the overboost voltage VOB. However, the scope of the present disclosure is not limited to a specific implementation method of the voltage regulator circuit 124b.

The pixel driving circuit 123b may generate one or more of various types of pixel control signals, such as the reset signal RX, the transmission signal TX, and the select signal SEL, based on the regulated voltage VREG. For example, the pixel driving circuit 123b may be implemented to generate pixel control signals based on the regulated voltage VREG rather than the overboost voltage VOB.

FIG. 10 is a circuit diagram exemplarily showing a configuration of a voltage converting circuit. Referring to FIGS. 1-10, the voltage converting circuit 122 may include first and second boost capacitors BCAPa, BCAPb, and first to fourth transistors TR1 to TR4.

In an embodiment, each of the first to fourth transistors TR1 to TR4 may be referred to as a boost transistor. However, the scope of the present disclosure is not limited to these terms.

In an embodiment, the first and second transistors TR1, TR2 may be implemented as n-type channel metal-oxide semiconductor (NMOS) transistors, and the third and fourth transistors TR3, TR4 may be implemented as p-type channel metal-oxide semiconductor (PMOS) transistors.

The first boost capacitor BCAPa may be connected between a first clock node NCLKa and a first node N1. The voltage level of the first clock node NCLKa may be determined based on a first masked clock signal MCLKa. The second boost capacitor BCAPb may be connected between a second clock node NCLKb and a second node N2. A voltage level of the second clock node NCLKb may be determined based on the second masked clock signal MCLKb.

The first masked clock signal MCLKa and the second masked clock signal MCLKb may have complementary phases. For example, when the first masked clock signal MCLKa is logic high, the second masked clock signal MCLKb may be logic low, and when the first masked clock signal MCLKa is logic low, the second masked clock signal MCLKb may be logic high.

In an embodiment, the first masked clock signal MCLKa and the second masked clock signal MCLKb may correspond to the masked clock signal MCLK described above with reference to FIGS. 1-10. For example, the masked clock signal MCLK may include a plurality of masked clock signals, such as the first masked clock signal MCLKa and the second masked clock signal MCLKb.

The first transistor TR1 may be connected between the first node N1 and the power supply line PSL. The first transistor TR1 may operate in response to the voltage level of the second node N2. The second transistor TR2 may be connected between the second node N2 and the power supply line PSL. The second transistor TR2 may operate in response to a voltage level of the first node N1.

The third transistor TR3 may be connected between the first node N1 and an output node NOUT. The third transistor TR3 may operate in response to a voltage level of the second node N2. The fourth transistor TR4 may be connected between the second node N2 and the output node NOUT. The fourth transistor TR4 may operate in response to a voltage level of the first node N1.

The second boost capacitor BCAPb may be charged with the supply voltage VDD while the first masked clock signal MCLKa is logic high. For example, while the second masked clock signal MCLKb is logic high, the voltage level of the second node N2 may rise to a voltage level corresponding to a sum of the power supply voltage VDD and the voltage level of the second masked clock signal MCLKb. The voltage level of the output node NOUT may be determined based on the voltage level of the second node N2.

Conversely, the first boost capacitor BCAPa may be charged with the supply voltage VDD while the second masked clock signal MCLKb is logic high. Thereafter, while the first masked clock signal MCLKa is logic high, the voltage level of the first node N1 may rise to a voltage level corresponding to a sum of the power supply voltage VDD and the voltage level of the first masked clock signal MCLKa. The voltage level of the output node NOUT may be determined based on the voltage level of the first node N1.

In an embodiment, each of the first transistor TR1 and the second transistor TR2 may correspond to the switching element SWE described above with reference to FIGS. 1-10. Each of the first boost capacitor BCAPa and the second boost capacitor BCAPb may correspond to the boost capacitor BCAP described above with reference to FIGS. 1-10.

For example, each of the first and second transistors TR1, TR2 may be repeatedly turned on and off according to the logic level of the first masked clock signal MCLKa. In this case, connection and disconnection between the power supply line PSL and the first boost capacitor BCAPa may be repeated depending on the logic level of the first masked clock signal MCLKa, and connection and disconnection between the power supply line PSL and the second boost capacitor BCAPb may be repeated. Accordingly, noise may be generated in the voltage level of the power supply line PSL due to the logic level transition of the first masked clock signal MCLKa. However, according to an embodiment of the present disclosure, since the logic levels of the first and second masked clock signals MCLKa, MCLKb may be kept constant during the masking periods TMSK, noise of the power supply line PSL during the masking period TMSK may be minimized.

FIG. 10 exemplarily illustrates configuration and operation of the voltage converting circuit 122, which is connected to the power supply line PSL and generates the overboost voltage VOB higher than the power supply voltage VDD, but the scope of the present disclosure is not limited thereto. For example, the voltage converting circuit 122 may be implemented to be connected to the ground supply line GSL and may generate the downboost voltage VDB lower than the ground voltage VGND.

In addition, FIG. 10 representatively illustrates the voltage converting circuit 122 of a 4-TR structure that generates the overboost voltage VOB based on two mutually complementary clock signals, but the scope of the present disclosure is not limited thereto. For example, the voltage converting circuit 122 may operate based on one clock signal or may be implemented with any number of transistors (e.g., two or more). That is, the scope of the present disclosure is not limited to a specific implementation scheme of the voltage converting circuit 122.

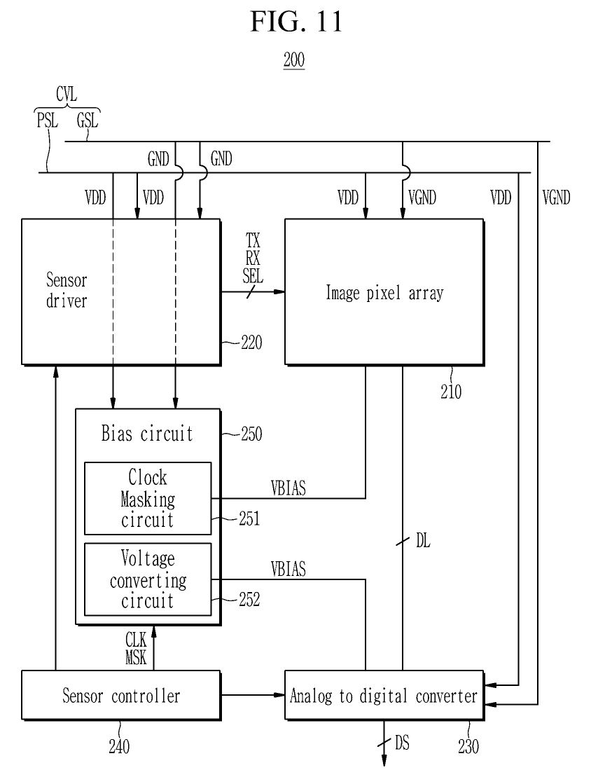

FIG. 11 is a block diagram showing the configuration of an image sensor device according to an embodiment. Referring to FIG. 1, the image sensor device 200 may include a ground supply line GSL, a power supply line PSL, an image pixel array 210, a sensor driver 220, an analog-to-digital converter 230, a sensor controller 240, and a bias circuit 250. The configuration and function of the image pixel array 210, sensor driver 220, analog-to-digital converter 230, and sensor controller 240 are similar to the configuration and function of the image pixel array 110, sensor driver 120, analog-to-digital converter 130, and sensor controller 140 described above with reference to FIG. 1, and therefore a detailed description is omitted.

The ground supply line GSL may provide ground voltage VGND to the bias circuit 250. The power supply line PSL may provide the power supply voltage VDD to the bias circuit 250.

The bias circuit 250 may include a clock masking circuit 251 and a voltage converting circuit 252. The clock masking circuit 251 may receive a clock signal CLK and a mask signal MSK. The clock masking circuit 251 may generate a masked clock signal MCLK based on the clock signal CLK and the mask signal MSK. The voltage converting circuit 252 may generate a bias voltage VBIAS by boosting at least one of the power supply voltage VDD and the ground voltage VGND based on the masked clock signal MCLK. For example, the bias voltage VBIAS may correspond to the boost voltage VBST described above. However, the scope of the present disclosure is not limited thereto, and the bias voltage VBIAS may also be implemented as a voltage generated based on the boost voltage VBST.

The voltage converting circuit 252 may provide the bias voltage VBIAS to components of the image sensor device 200. For example, the voltage converting circuit 252 may provide the bias voltage VBIAS to a substrate of at least one of the image pixel array 210 and the analog-to-digital converter 230. However, the scope of the present disclosure is not limited to a specific location where the bias voltage VBIAS is provided.

While the present disclosure has been described with reference to embodiments thereof, it will be apparent to those of ordinary skill in the art that various changes and modifications may be made thereto without departing from the spirit and scope of the present disclosure.

What is claimed is:

1. An image sensor device, comprising:
a common voltage line;
an image pixel;
a voltage converting circuit configured to generate a boost voltage for a voltage level of the common voltage line based on a masked clock signal; and
a pixel driving circuit configured to provide one or more pixel control signals to the image pixel, wherein the one or more pixel control signals are generated based on the boost voltage.

2. The image sensor device of claim 1, wherein:
a first absolute value of the boost voltage is greater than a second absolute value of the voltage level of the common voltage line.

3. The image sensor device of claim 2, wherein:
the common voltage line is a power supply line,
the voltage level of the common voltage line is a power supply voltage,
the boost voltage is a greater than the power supply voltage.

4. The image sensor device of claim 2, wherein:
the common voltage line is a ground supply line,
the voltage level of the common voltage line is a ground voltage,
the boost voltage is lower than the ground voltage.

5. The image sensor device of claim 1, further comprising:
a clock masking circuit configured to generate the masked clock signal having a constant logic level during a masking period, wherein the clock masking circuit is configured to receive a mask signal and a clock signal, and configured to generate the masked clock signal by masking the clock signal in response to the mask signal.

6. The image sensor device of claim 5, wherein:
the one or more pixel control signals include a reset signal, a transmission signal, and a select signal, and
the pixel driving circuit is configured to maintain constant logic levels of the reset signal, the transmission signal, and the select signal during the masking period.

7. The image sensor device of claim 5, further comprising:
a ramp generation circuit configured to generate a ramp signal having a voltage level that changes linearly during a first ramp period and a second ramp period, and
an analog-to-digital converting circuit configured to:
identify a first pixel reset voltage for the image pixel based on a voltage level of the ramp signal during the first ramp period;
identify a first pixel data voltage for the image pixel based on a voltage level of the ramp signal during the second ramp period; and
generate a first digital signal corresponding to a difference between the first pixel reset voltage and the first pixel data voltage.

8. The image sensor device of claim 7, wherein the masked clock signal has a constant logic level during a first masking period included in the first ramp period and during a second masking period included in the second ramp period.

9. The image sensor device of claim 8, wherein a length of the second masking period is equal to, or longer than, a length of the first masking period.

10. The image sensor device of claim 8, wherein:
an end time point of the first masking period is earlier than an end time point of the first ramp period, and
an end time point of the second masking period is earlier than an end time point of the second ramp period.

11. The image sensor device of claim 8, wherein:
a start time point of the first masking period is later than a start time point of the first ramp period, and
a start time point of the second masking period is later than a start time point of the second ramp period.

12. The image sensor device of claim 8, wherein:
a time interval between an end time point of the second masking period and an end time point of the second ramp period is longer than a time interval between a start time point of the second masking period and a start time point of the second ramp period.

13. The image sensor device of claim 8, further comprising a voltage regulator circuit configured to generate a regulated voltage based on the boost voltage,
wherein the pixel driving circuit is configured to generate at least one of a reset signal, a transmission signal, and a select signal based on the regulated voltage.

14. The image sensor device of claim 1, wherein:
the voltage converting circuit includes a switching circuit and a boost capacitor, and
the switching circuit is configured to electrically connect the boost capacitor to the common voltage line in response to a logic level of the masked clock signal.

15. An image sensor device, comprising:
an image pixel array including an image pixel;
a sensor driver configured to control the image pixel;
a ramp generation circuit configured to generate a ramp signal having a voltage level that changes linearly during a first ramp period and a second ramp period;
an analog-to-digital converting circuit configured to identify a first pixel reset voltage for the image pixel based on a voltage level of the ramp signal during the first ramp period, and configured to identify a first pixel data voltage for the image pixel based on a voltage level of the ramp signal during the second ramp period; and
a sensor controller configured to provide a mask signal to the sensor driver,
wherein the mask signal has a first logic level during a first masking period included in the first ramp period and a second masking period included in the second ramp period, and the mask signal has a second logic level during a time period between the first ramp period and the second ramp period.

16. The image sensor device of claim 15, wherein the sensor driver comprises:
a clock masking circuit configured to generate a masked clock signal based on the mask signal;
a voltage converting circuit configured to generate a boost voltage for a voltage level of a common voltage line connected to the image pixel, wherein the boost voltage is generated based on the masked clock signal; and
a pixel driving circuit configured to provide one or more pixel control signals to the image pixel, wherein the one or more pixel control signals are generated based on the boost voltage.

17. The image sensor device of claim 16, wherein:
the one or more pixel control signals include a reset signal, a transmission signal, and a select signal, and
the pixel driving circuit is configured to maintain constant logic levels of the reset signal, the transmission signal, and the select signal during the first and second masking periods.

18. The image sensor device of claim 15, wherein:
a length of the second masking period is equal to, or longer than, a length of the first masking period.

19. An image sensor device configured to receive a power supply voltage, the image sensor device comprising:
a clock masking circuit configured to generate a masked clock signal based on a mask signal and a clock signal;
a voltage converting circuit configured to generate a boost voltage that is higher than the power supply voltage based on the masked clock signal; and
an image pixel array configured to be controlled based on the boost voltage.

20. The image sensor device of claim 19, wherein the masked clock signal is configured to:
have a constant logic level while the mask signal is at a first logic level; and
toggle while the mask signal is at a second logic level.
